(19) United States
(12) Patent Application Publication
(10) Pub. No.: US 2014/0095296 A1
(43) Pub. Date: Apr. 3, 2014

(54) SYSTEMS AND METHODS FOR ANALYZING AND REPORTING GEOFENCE PERFORMANCE METRICS

(71) Applicants: Jessica R. Angell, Boston, MA (US); Neala F. Polachi, Boston, MA (US)

(72) Inventors: Jessica R. Angell, Boston, MA (US); Neala F. Polachi, Boston, MA (US)

(73) Assignee: eBay Inc., San Jose, CA (US)

(21) Appl. No.: 13/674,003

(22) Filed: Nov. 10, 2012

Related U.S. Application Data
(60) Provisional application No. 61/708,481, filed on Oct. 1, 2012.

(51) Int. Cl. G06Q 30/02

(52) U.S. Cl. CPC G06Q 30/0246
USPC 705/14.45

(57) ABSTRACT

A method of tracking an advertising campaign is provided. Information about clicks made on advertisements distributed to mobile devices in the advertising campaign as well as information about numbers of impressions made on mobile devices in the advertising campaign is retrieved. Click-through-rates of impressions within a defined geofence are calculated and broken down into click-through-rates in each of a plurality of different sub-areas within the defined geofence based on physical locations identified in metadata of the information about clicks. A report may then be generated for the defined geofence identifying the click-through-rates for the different sub-areas within the defined geofence.

### CROSS-REFERENCE TO RELATED APPLICATIONS

This application claims priority to U.S. Provisional Application No. 61/708,481, filed Oct. 1, 2012, which application is incorporated herein by reference in its entirety.

### BACKGROUND

The advent of mobile devices with location determination capabilities has sparked development of a wide variety of location-based services, including location-based advertising. Merchants with physical locations are interested in driving local traffic through advertising on mobile devices. The combination of location-based services and mobile advertising has enabled merchants to target mobile device users within specified areas.

### BRIEF DESCRIPTION OF DRAWINGS

FIG. 1 is a network diagram depicting a networked or network based system, according to an example embodiment, having various components configured for exchanging data over a network.

FIG. 2 is a network diagram depicting a networked or network based system, according to another example embodiment, having various components configured for exchanging data over a network.

FIG. 3 is a diagram illustrating a system, in accordance with an example embodiment, of multiple tiers of users receiving a coupon.

FIG. 4 is a network diagram depicting a networked or network based system, according to another example embodiment, having various components configured for exchanging data over a network.

FIGS. 5A-5G are diagrams depicting an example, in accordance with an example embodiment, of a coupon value dynamic adjustment table.

FIGS. 6A and 6B are diagrams illustrating a system, in accordance with an example embodiment, of tracking electronic coupons.

FIG. 7 is an interaction diagram illustrating a method, in accordance with an example embodiment, of validating an electronic incentive provided to users.

FIG. 8 is a line drawing of another graphical POI (Point of Interest) geofence report, according to another example embodiment.

FIG. 9 is a line drawing of another graphical POI geofence report, according to another example embodiment.

FIG. 10 is an interaction diagram illustrating a method, in accordance with an example embodiment, for tracking an advertising campaign.

FIG. 11 is a flowchart illustrating a method, in accordance with an example embodiment, for tracking an advertising campaign.

FIG. 12 is a block diagram of machine in the example form of a computer system within which instructions for causing the machine to perform any one or more of the methodologies discussed herein may be executed.

### DEFINITIONS

Location—For the purposes of this specification and the associated claims, the term “location” is used to refer to a geographic location, such as a longitude/latitude combination or a street address. The term location is also used within this specification and claims in reference to a physical location associated with a retail outlet (e.g., store).

Real-time—For the purposes of this specification and the associated claims, the term “real-time” is used to refer to calculations or operations performed on-the-fly as events occur or input is received by the operable system. However, the use of the term “real-time” is not intended to preclude operations that cause some latency between input and response, so long as the latency is an unintended consequence induced by the performance characteristics of the machine.

POI (point of interest)—For the purposes of this specification and the associated claims, the term POI is used as shorthand for point of interest. A point of interest can include any physical location and will often relate to a retail location or event venue, among other things.

Geofence—For the purposes of this specification and the associated claims, the term geofence refers to an imaginary geographic boundary. Geofences are often, but not always, defined as a radius around a particular POI. However, a geofence can be any shape or size and can include many POIs or none. For convenience of description, geofences are depicted within this application as circles; however, the discussed systems and methods can be applied to any shape of geofence.

Clicks—the effectiveness of advertising on digital devices such as mobile devices is often measured in terms of clicks. While the term click derives from the action of users navigating a cursor to an advertisement using a mouse and “clicking” on the advertisement by depressing a mouse button, with the increase in popularity of devices lacking a traditional mouse, or even a traditional button to select items, such as devices containing touchscreens, the term is now broadly used to cover any action taken by the user to select an advertisement, such as by “tapping” on the touchscreen or pressing enter on a keyboard. For purpose of this specification, the broader definition is used.

CTR—Click-Through-Rate is a common digital advertising metric used to measure effectiveness of a digital advertisement. CTR can be calculated by dividing the number of clicks a digital advertisement received by the total number of impressions (e.g., views). This definition is provided merely for informational purposes with no intent to create a special definition for CTR.

### DETAILED DESCRIPTION

Example systems and methods for analyzing and reporting geofence performance are described. In some example embodiments, the systems and methods for analyzing and reporting geofence performance allow a user to determine how a particular location-based advertising campaign performed within different geographic segments of the target geofence (or geofences). In an example, an advertising campaign designed to target geofences encompassing a ten-mile radius around a POI can be broken down into one-mile rings to determine how distance from the POI affected advertising response.

In another example, geofence performance can be analyzed and reported based on proximity to points of interest within the geofence. For example, the locations where mobile device users have extra time to spend on their devices, such as at movie theaters or sporting events (e.g., waiting for events to occur) may have vastly different click-through rates than locations where the users are typically more rushed (e.g., in the middle of a desolate highway). In such instances, it may be more relevant to present results in regard to the proximity to these points of interest rather than merely as concentric circles radiating away from a center of a geofence.

In another example, information about the types of users typically located in an area can be used to define sub-areas within a geofence to analyze and report. For example, in some areas political views are more homogenous than in other areas. The state of California, for example, is largely Democratic-leaning; however, there are strong pockets of both Republican-leaning and Democratic-leaning districts, areas, even streets. Dividing the geofence based on these types of political boundaries may be helpful for an advertiser who, for example, represents a political campaign, or simply is selling a product that is more likely to appeal to one demographic or the other. Similar divisions of the geofence could be created based on other demographics, such as age, gender, level of education, income level, home values, etc.

In the following description, for purposes of explanation, numerous specific details are set forth in order to provide a thorough understanding of example embodiments. It will be evident, however, to one skilled in the art that the present disclosure may be practiced without these specific details. It will also be evident that a location-based publication system is not limited to the examples provided and may include other scenarios not specifically discussed.

Location-targeted advertising is based on the premise that users' locations and their proximity to a POI impact the performance of the advertising campaign. As noted above, location-based advertising has developed as the result of readily available location-aware mobile devices. However, beyond the application of a geofence to a POI, advertisers have not historically been able to analyze response characteristics based on location within a geofence. The present subject matter enables advertisers to understand how location of the target audience relative to the POI and the geofence impacts response characteristics (e.g., impressions, clicks, and CTR). The systems and methods discussed can enable advertisers to break-down campaign performance by individual POI across millions of locations: city, state, and zip code; analyze performance of their geofences by individual mileage rings to understand precisely where within a geofence consumers are taking action; and identify the audience profile of consumers in pre-and-post campaign analysis. The provided analysis and reports assist in determining where consumers are when they engage with the targeted advertising.

The analysis discussed herein can assist in analyzing performance of particular advertising campaigns, such as store openings, national campaigns, regional campaigns, or temporal campaigns (e.g., holiday weekend promotions). Detailed intra-geofence analytics allow advertisers the ability to adjust geofencing, change creative (advertising) or offers based on geography, or better focus future media buys. For example, the analytics discussed herein can demonstrate that certain offer types are less effective five miles from a POI versus two miles from a POI. Additional demographic data can also be analyzed to provide geographic and demographic reporting on campaign performance.

### Example System

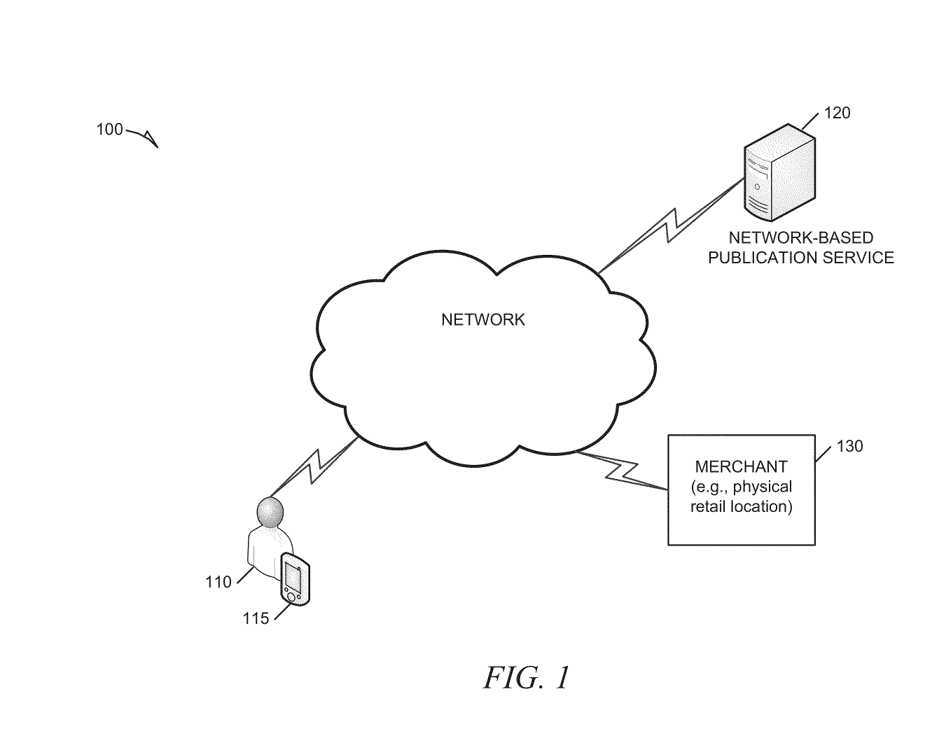

FIG. 1 is a block diagram depicting a system 100 for delivering and tracking location-based advertising campaigns, according to an example embodiment. The system 100 can include a user 110, a network-based publication system 120, and a merchant 130. In an example, the user 110 can connect to the network-based publication system 120 via a mobile device 115 (e.g., smart phone, PDA, laptop, or similar mobile electronic device capable of some form of data connectivity). The network-based publication system 120 can interact with any of the systems used by merchant 130 for operation of the merchant's retail or service business. In an example, the network-based publication system 120 can work with both a point of sale system and an inventory system to obtain access to inventory available at individual retail locations run by the merchant 130 and match merchandise on which the merchant 130 wants to offer deals via the network-based publication system 120. In an example, the network-based publication system 120 can distribute, monitor, and analyze location-based advertising campaign on behalf of the merchant 130. User 110 can represent one of a large number of potential targets of an advertising campaign implemented by the network-based publication system 120. In an example, the network-based publication system 120 can receive location data from user 110 (as well as other users) to determine whether user 110 should received location-based advertising published by the network-based publication system 120.

### Example Operating Environment

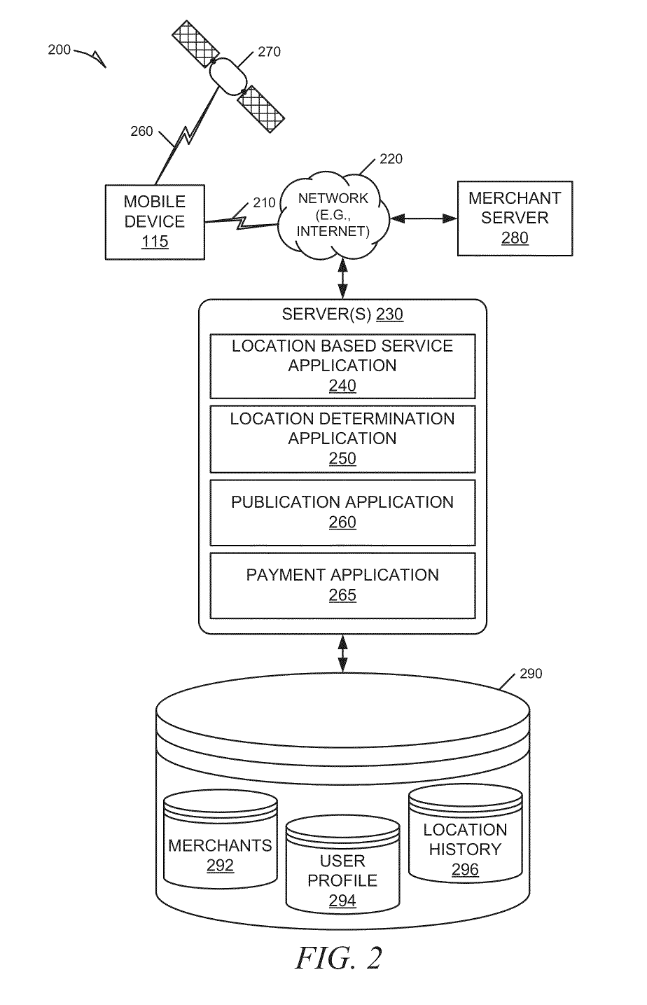

FIG. 2 is a block diagram illustrating an environment for operating a mobile device, according to an example embodiment. The environment 200 is an example environment within which location-based advertising can be distributed and tracked. The environment 200 can include a mobile device 115, a communication connection 210, a network 220, servers 230, a communication satellite 270, a merchant server 280, and a database 290. The servers 230 can optionally include location-based service application 240, location determination application 250, publication application 260, and payment application 265. The database 290 can optionally include merchant databases 292, user profile database 294, and/or location history database 296. The mobile device 115 represents one example device that can be utilized by a user to receive offers (e.g., advertisements) and process payments. The mobile device 115 may be any of a variety of types of devices (for example, a cellular telephone, a personal digital assistant (PDA), a Personal Navigation Device (PND), a handheld computer, a tablet computer, a notebook computer, or other type of movable device). The mobile device 115 may interface via a connection 210 with a communication network 220. Depending on the form of the mobile device 115, any of a variety of types of connections 210 and communication networks 220 may be used.

For example, the connection 210 may be Code Division Multiple Access (CDMA) connection, a Global System for Mobile communications (GSM) connection, or other type of cellular connection. Such connection 210 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, or other data transfer technology (e.g., fourth generation wireless, 4G networks). When such technology is employed, the communication network 220 may include a cellular network that has a plurality of cell sites of overlapping geographic coverage, interconnected by cellular telephone exchanges. These cellular telephone exchanges may be coupled to a network backbone (for example, the public switched telephone network (PSTN), a packet-switched data network, or to other types of networks).

In another example, the connection 210 may be Wireless Fidelity (Wi-Fi, IEEE 802.11x type) connection, a Worldwide Interoperability for Microwave Access (WiMAX) connection, or another type of wireless data connection. In such an embodiment, the communication network 220 may include one or more wireless access points coupled to a local area network (LAN), a wide area network (WAN), the Internet, or other packet-switched data network.

In yet another example, the connection 210 may be a wired connection, for example an Ethernet link, and the communication network 220 may be a LAN, a WAN, the Internet, or other packet-switched data network. Accordingly, a variety of different configurations are expressly contemplated.

A plurality of servers 230 may be coupled via interfaces to the communication network 220, for example, via wired or wireless interfaces. These servers 230 may be configured to provide various types of services to the mobile device 115. For example, one or more servers 230 may execute location-based service (LBS) applications 240, which interoperate with software executing on the mobile device 115, to provide LBSs to a user. LBSs can use knowledge of the device's location, and/or the location of other devices, to provide location-specific information, recommendations, notifications, interactive capabilities, and/or other functionality to a user. For example, an LBS application 240 can provide location data to a network-based publication system 120 (FIG. 1), which can then be used to assist in generating offers relevant to the user's current location and enable payment via a network-based payment system. Knowledge of the device's location, and/or the location of other devices, may be obtained through interoperation of the mobile device 115 with a location determination application 250 executing on one or more of the servers 230. Location information may also be provided by the mobile device 115, without use of a location determination application, such as application 250. In certain examples, the mobile device 115 may have some limited location determination capabilities that are augmented by the location determination application 250. In some examples, the servers 230 can also include publication application 260 for providing location-aware advertisements based on geofence enabled advertising campaigns. In certain examples, location data can be provided to the publication application 260 by the location determination application 250. In some examples, the location data provided by the location determination application 250 can include merchant information (e.g., identification of a retail location). In certain examples, the location determination application 250 can receive signals via the network 220 to further identify a location. For example, a merchant may broadcast a specific IEEE 802.11 service set identifier (SSID) that can be interpreted by the location determination application 250 to identify a particular retail location. In another example, the merchant may broadcast an identification signal via radio-frequency identification (RFID), near-field communication (NFC), or a similar protocol that can be used by the location determination application 250.

### Example Mobile Device

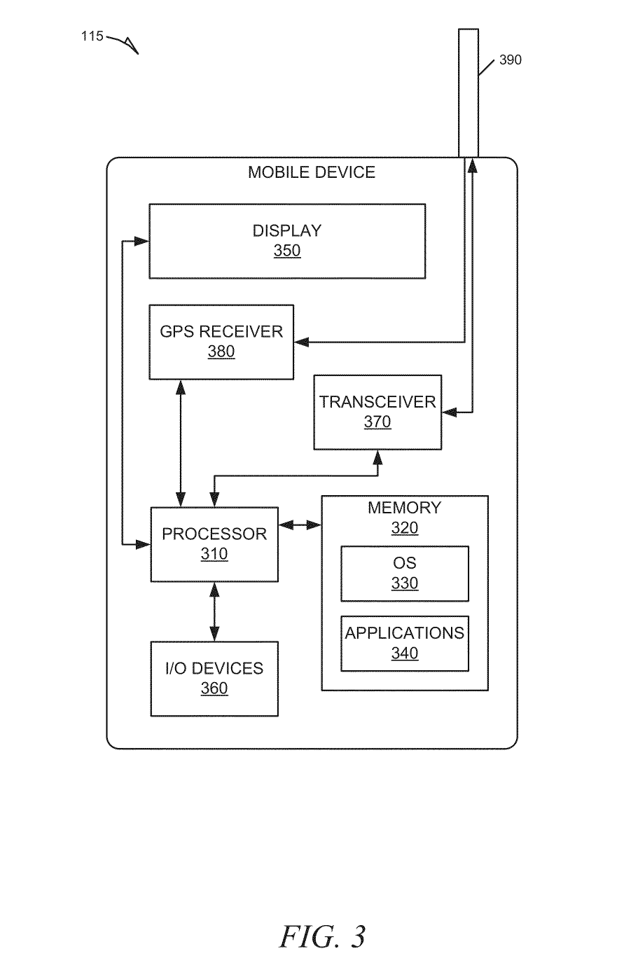

FIG. 3 is a block diagram illustrating a mobile device, according to an example embodiment. The mobile device 115 may include a processor 310. The processor 310 may be any of a variety of different types of commercially available processors suitable for mobile devices (for example, an XScale architecture microprocessor, a Microprocessor without Interlocked Pipeline Stages (MIPS) architecture processor, or another type of processor). A memory 320, such as a Random Access Memory (RAM), a Flash memory, or other type of memory, is typically accessible to the processor 310. The memory 320 may be adapted to store an operating system (OS) 330, as well as application programs 340, such as a mobile location enabled application that may provide LBSs to a user. The processor 310 may be coupled, either directly or via appropriate intermediary hardware, to a display 350 and to one or more input/output (I/O) devices 360, such as a keypad, a touch panel sensor, a microphone, and the like. Similarly, in some embodiments, the processor 310 may be coupled to a transceiver 370 that interfaces with an antenna 390. The transceiver 370 may be configured to both transmit and receive cellular network signals, wireless data signals, or other types of signals via the antenna 390, depending on the nature of the mobile device 115. In this manner, the connection 210 with the communication network 220 (FIG. 2) may be established. Further, in some configurations, a GPS receiver 380 may also make use of the antenna 390 to receive GPS signals.

### Example Platform Architecture

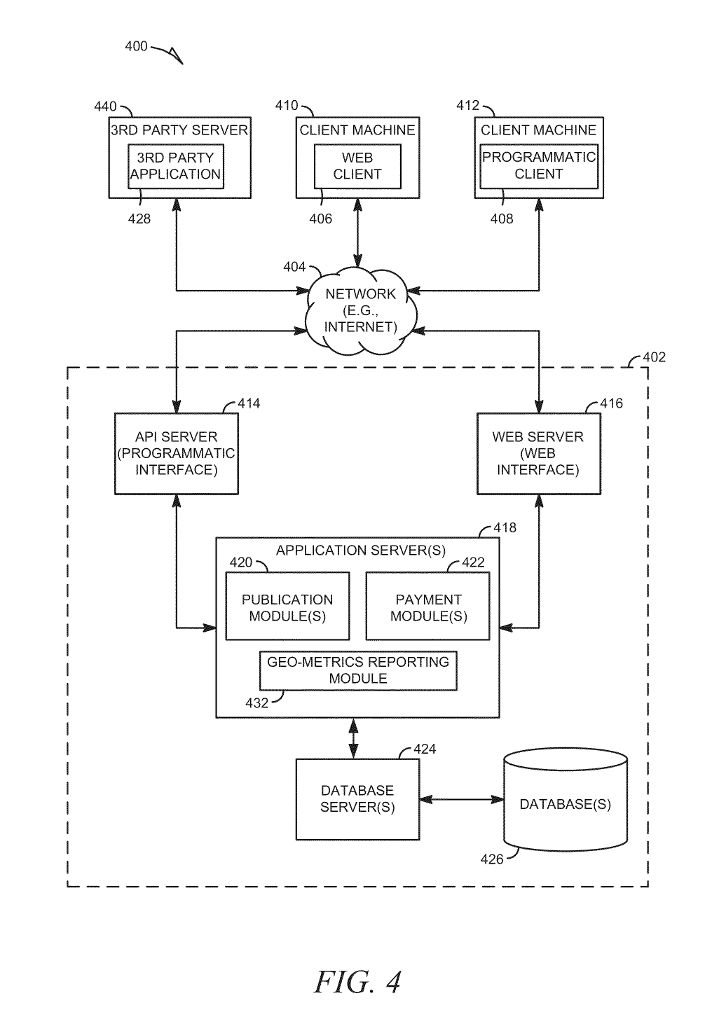

FIG. 4 is a block diagram illustrating a network-based system for delivering publication services including detailed geo-metrics reporting on geofenced ad campaigns, according to an example embodiment. The block diagram depicts a network-based system 400 (in the exemplary form of a client-server system), within which an example embodiment can be deployed as described. A networked system 402, in the example form of a network-based publication and reporting system, that provides server-side functionality, via a network 404 (e.g., the Internet or WAN) to one or more client machines 410, 412. FIG. 4 illustrates, for example, a web client 406 (e.g., a browser, such as the Internet Explorer browser developed by Microsoft Corporation of Redmond, Wash. State) and a programmatic client 408 (e.g., WHERE™ smartphone application from eBay, Inc. of San Jose, Calif.) executing on respective client machines 410 and 412. In an example, the client machines 410 and 412 can be in the form of a mobile device, such as mobile device 115 of FIG. 1.

An Application Programming Interface (API) server 414 and a web server 416 are coupled to, and provide programmatic and web interfaces respectively to, one or more application servers 418. The application servers 418 host one or more publication module(s) 420 (in certain examples, these can also include commerce modules, advertising modules, and marketplace modules, to name a few), payment module(s) 422, and geo-metrics reporting module 432. The application server(s) 418 is, in turn, shown to be coupled to one or more database server(s) 424 that facilitate access to one or more database(s) 426. In some examples, the application server(s) 418 can access the database(s) 426 directly without the need for database server(s) 424.

The publication module(s) 420 may provide a number of publication functions and services to users that access the networked system 402. The payment module(s) 422 may likewise provide a number of payment services and functions to users. The payment module(s) 422 may allow users to accumulate value (e.g., in a commercial currency, such as the U.S. dollar, or a proprietary currency, such as “points”) in accounts, and then later to redeem the accumulated value for products (e.g., goods or services) that are advertised or made available via the various publication module(s) 420, within retail locations, or within external online retail venues. The payment module(s) 422 may also be configured to present or facilitate a redemption of offers, generated by the geo-metrics reporting module 432, to a user during checkout (or prior to checkout, while the user is still actively shopping). The payment module(s) 422 can also be configured to enable mobile payment processing. The publication module(s) 420 may also provide real-time location-aware offers (e.g., coupons or immediate discount deals on targeted products or services) to users of the networked system 402. The offer options can be personalized based on current location, time of day, user profile data, past purchase history, or recent physical or online behaviors recorded by the network-based system 400, among other things. Location-based offers can be targeted to users within geofences centered on POIs defined within a particular campaign. The geo-metrics reporting module 432 can deliver detailed analytics on geofenced campaigns published by the publication module(s) 420.

While the publication module(s) 420, payment module(s) 422, and geo-metrics reporting module 432 are shown in FIG. 4 to all form part of the networked system 402, it will be appreciated that, in alternative embodiments, the payment module(s) 422 may form part of a payment service that is separate and distinct from the networked system 402, such as an external network-based payment service. Additionally, in some examples, the geo-metrics reporting module 432 may be part of the payment service or may form an offer generation service separate and distinct from the networked system 402.

Further, while the system 400 shown in FIG. 4 employs a client-server architecture, the present inventive subject matter is of course not limited to such an architecture, and could equally well find application in a distributed, or peer-to-peer, architecture system, for example. The various publication module(s) 420, payment module(s) 422, and geo-metrics reporting module 432 could also be implemented as standalone systems or software programs, which do not necessarily have networking capabilities.

The web client 406 accesses the various publication module(s) 420, payment module(s) 422, and geo-metrics reporting module 432 via the web interface supported by the web server 416. Similarly, the programmatic client 408 accesses the various services and functions provided by the publication module(s) 420, payment module(s) 422, and geo-metrics reporting module 432 via the programmatic interface provided by the API server 414. The programmatic client 408 may, for example, be a smartphone application (e.g., the PAYPAL™ payment application developed by eBay, Inc., of San Jose, Calif.) to enable users to make a various of payments directly from their smartphones.

FIG. 4 also illustrates a third party application 428, executing on a third party server machine 440, as having programmatic access to the networked system 402 via the programmatic interface provided by the API server 414. For example, the third party application 428 may, utilizing information retrieved from the networked system 402, support one or more features or functions on a website hosted by the third party. The third party website may, for example, provide one or more promotional, marketplace or payment functions that are supported by the relevant applications of the networked system 402. Additionally, the third party website may provide merchants with access to the geo-metrics reporting module 432 for configuration purposes and report viewing. In certain examples, merchants can use programmatic interfaces provided by the API server 414 to develop and implement rules-based pricing schemes that can be implemented via the publication modules 420 with results reported via the geo-metrics reporting module 432.

### Example Tabular Report

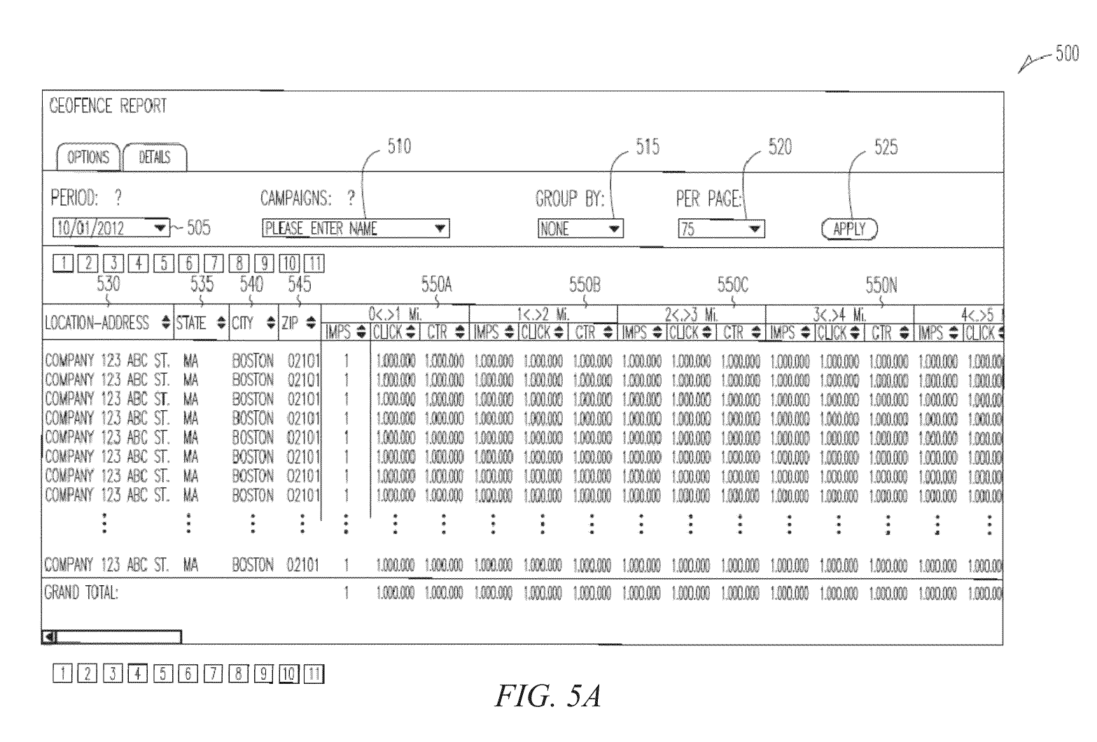

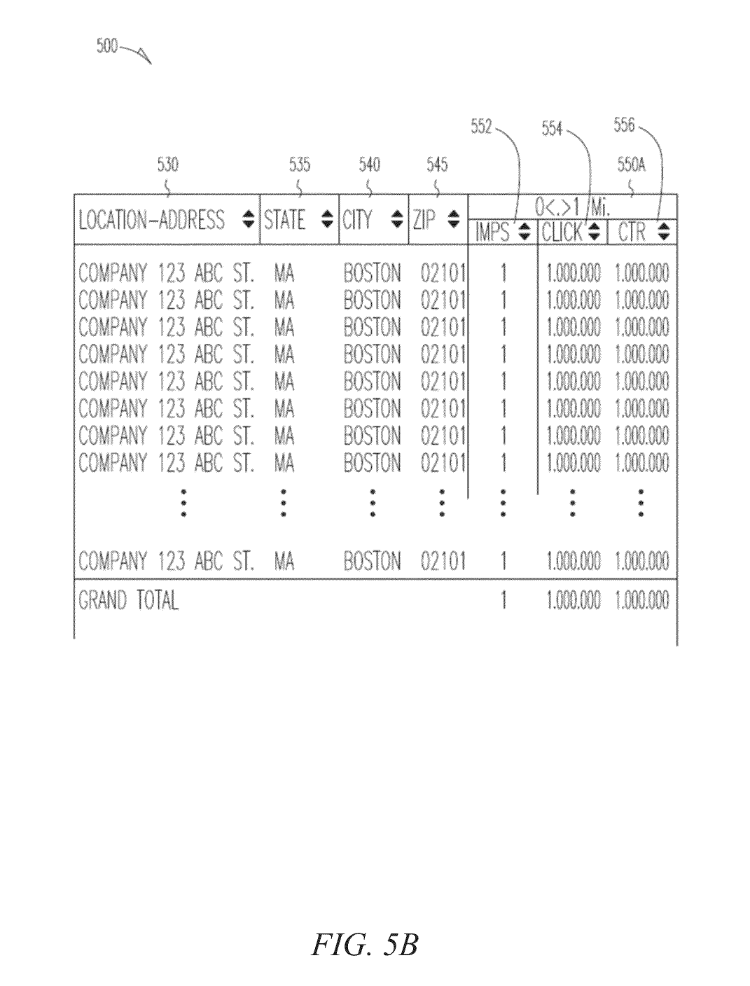

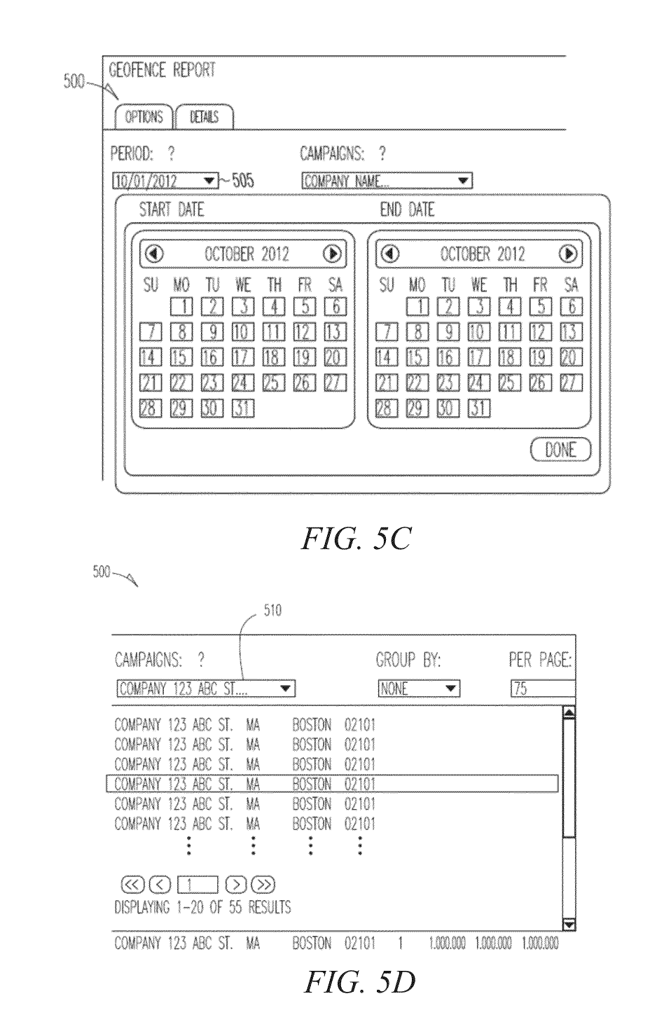

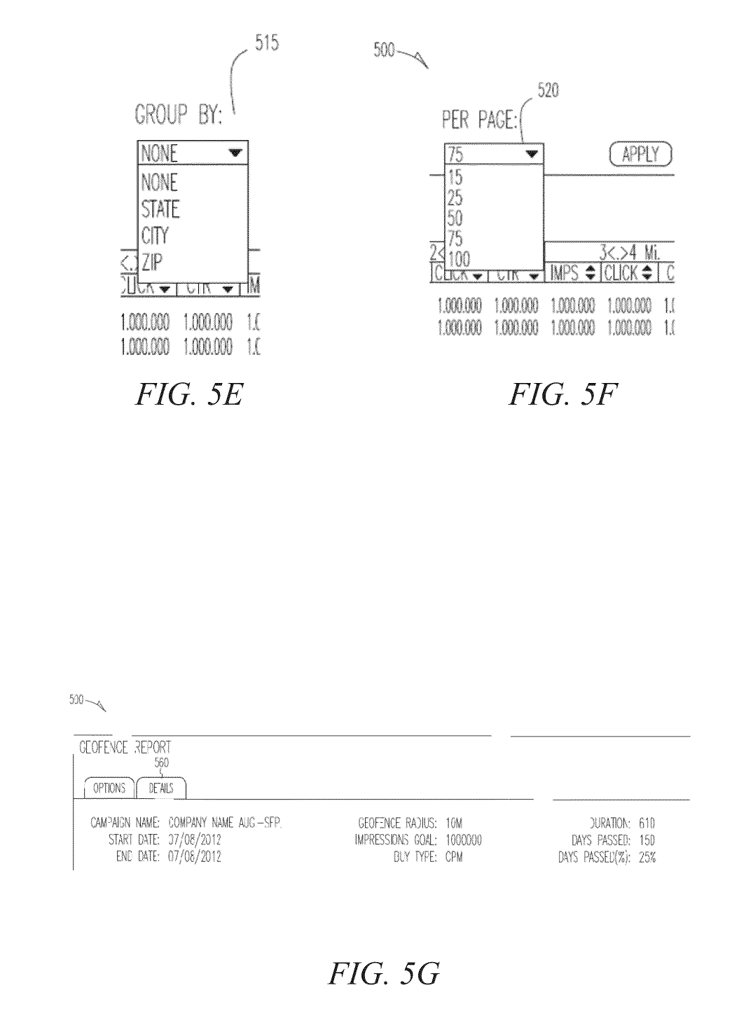

FIGS. 5A-5G illustrate aspects of a user interface depicting a geofence report 500, according to an example embodiment. In this example, geofence report 500 can include visualization controls such as: reporting period 505, campaign reporting 510, group by filter 515 (city and state), results per page 520 and filter application (apply) button 525. The standard format of geofence report 500 includes columns of data such as: POI location (address) 530, POI state 535, POI city 540, and POI zip 545. The standard format report breaks down geofence performance data into geofence rings 550A-550N (collectively referred to as geofence rings or segments 550). In this example, geofences can be broken down into one-mile rings for zero to 10 miles out from POI, into five-mile rings for 10 to 20 miles out from POI, and into 10-mile rings for 20 to 50 miles out form POI. Other examples can break down geofences into different ring sizes (for circular geofences). Geofences of different shape may use similar or different techniques for segmenting the geofence for analysis, such as contour lines mimicking the outer boundary working progressively in towards the center of the geofence. FIGS. 5B-5G provide more detailed illustrations of portions of geofence report 500, as well as report details 560 in FIG. 5G.

### Example Graphical Report

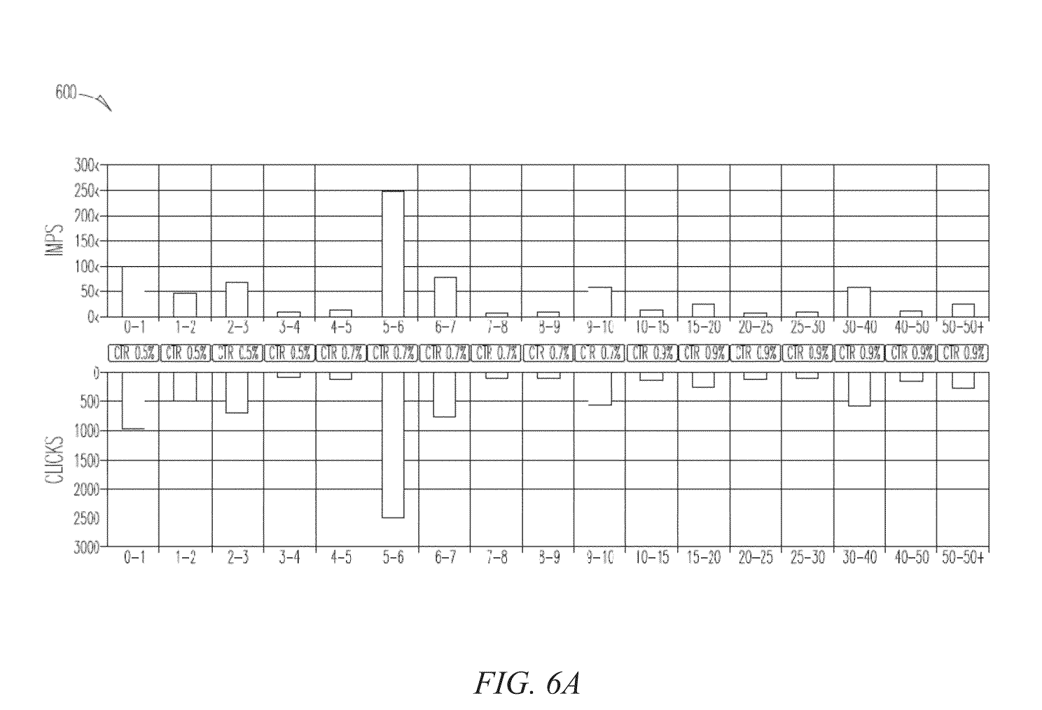

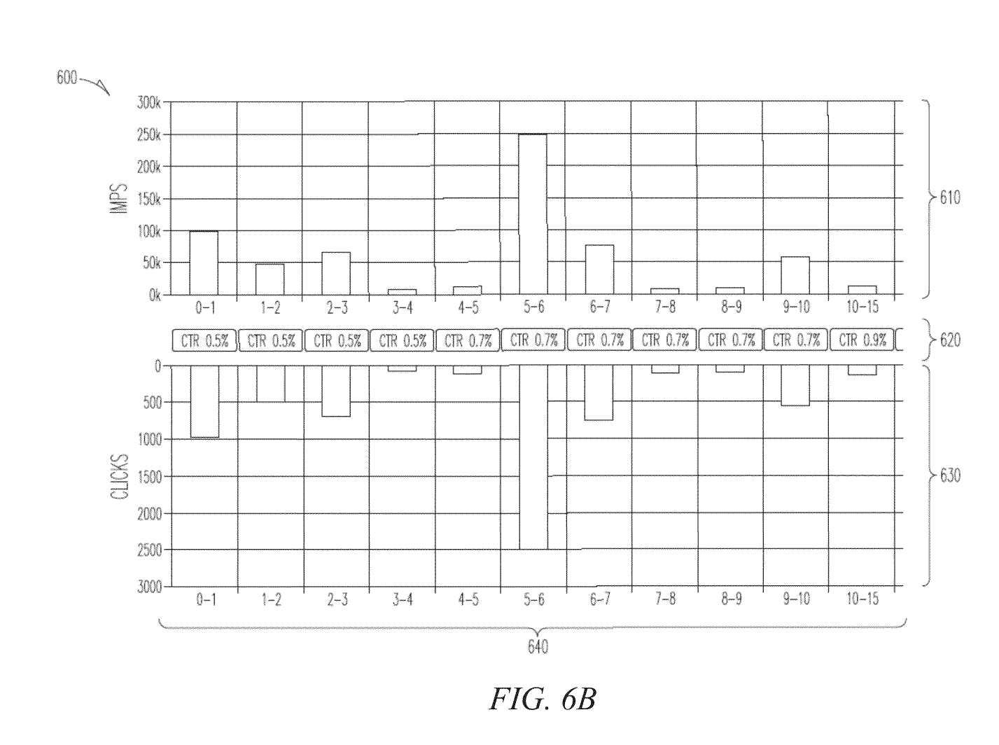

FIGS. 6A-6B are illustrations of a graphical geofence report 600, according to an example embodiment. The example in FIG. 6A illustrates a complete report illustration. The graphical geofence report 600 in FIG. 6B enlarges a section of the report to better illustrate the individual features of the report. Graphical geofence report 600 can include impressions 610, CTR 620, and Clicks 630 as Y-axis components, with geofence rings 640 across the X-axis. In some examples, CTR 620 can be color coded (binned) based on certain pre-defined thresholds. CTR below a specified level can be colored red to indicate poor performance, while CTR above a second specified threshold can be colored green to indicate good performance. In this example, CTR between the two thresholds can be colored yellow to indicate acceptable performance. Other examples can implement additional thresholds and color coding.

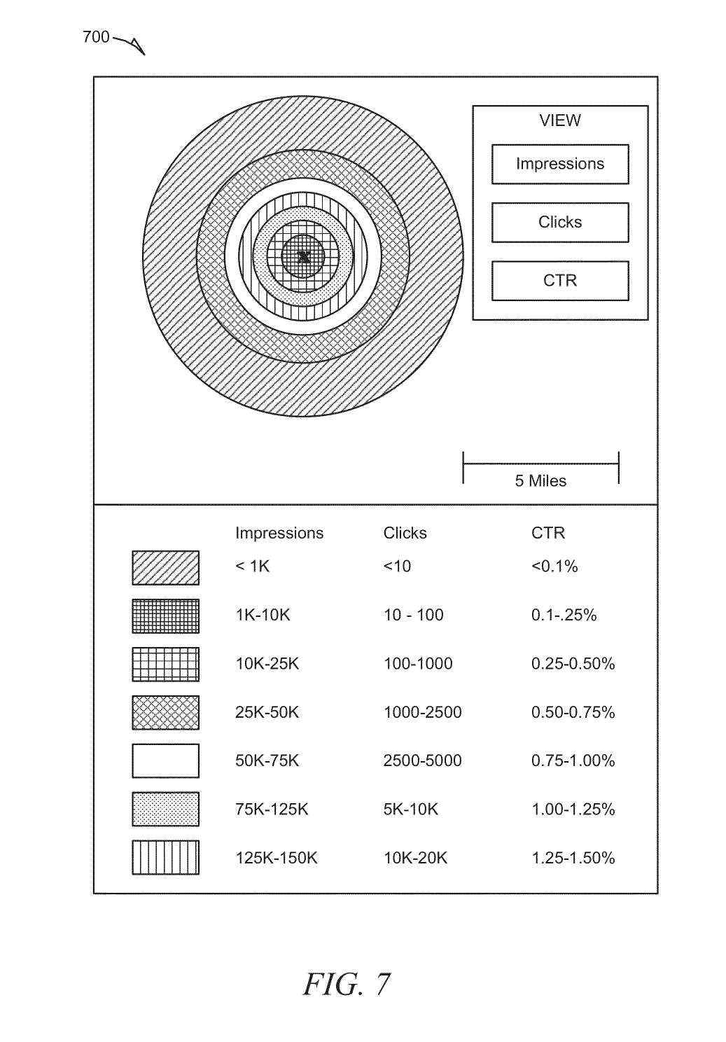

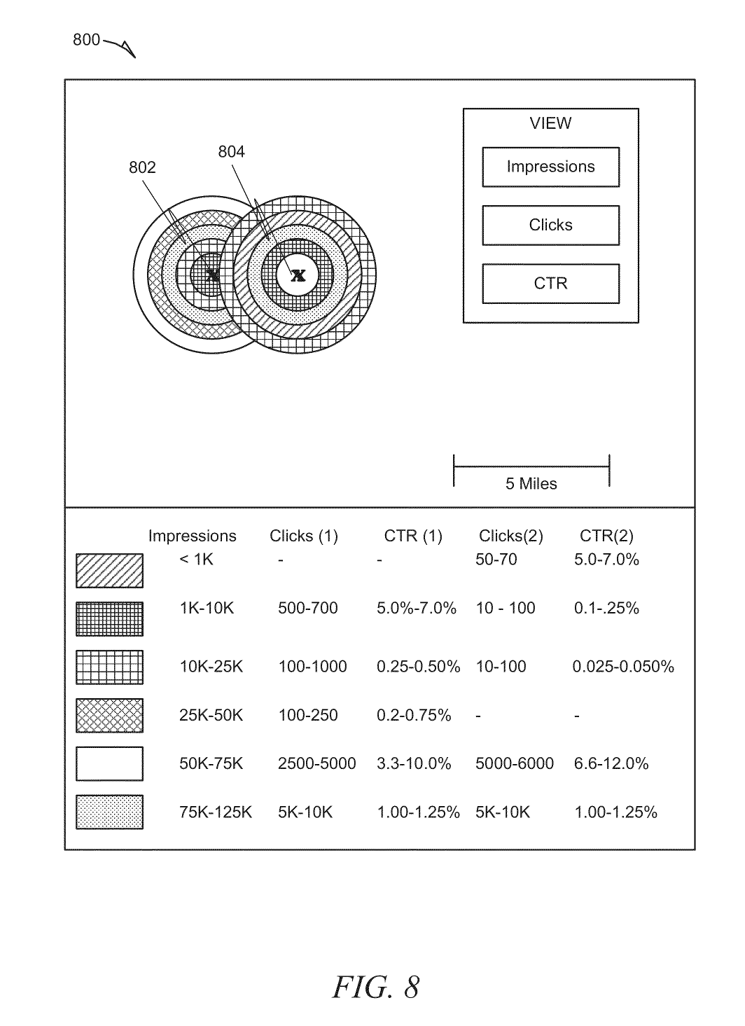

FIG. 7 is a line drawing of a graphical POI geofence report 700, according to an example embodiment. In this example, the graphical POI geofence report 700 can provide a graphical visualization of impressions, clicks, or CTR for a single POI (or aggregated for all POIs within a particular campaign). The graphical POI geofence report 700 uses color coding or shading (shading/color coding illustrated with different fill patterns in line drawing) to visually depict different performance ranges according to the currently viewed metric (e.g., impressions, clicks, or CTR).

FIG. 8 is a line drawing of another graphical POI geofence report 800, according to another example embodiment. In this example, the graphical POI geofence report 800 depicts concentric circles like in FIG. 7, except rather than centering the concentric circles around a center of a geofence, there are multiple groups of concentric circles centered around multiple points of interest 802, 804 within the geofence report 800. As can be seen, the concentric circles may overlap for different points of interest 802, 804. As described above, this allows the system to provide better analysis for points of interest where geo-fences for POIs overlap.

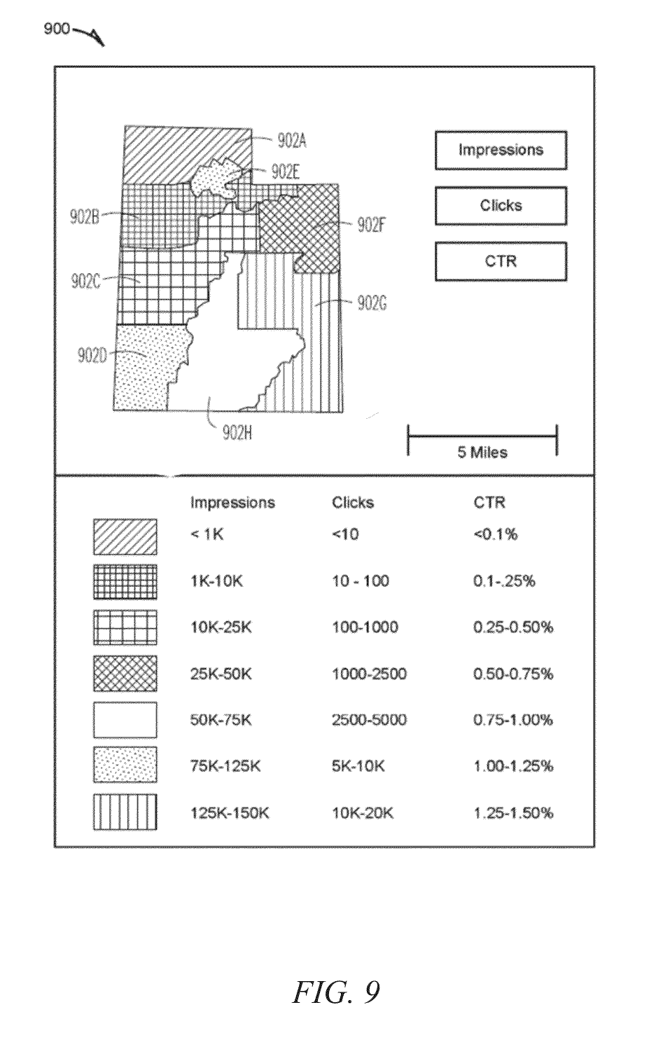

FIG. 9 is a line drawing of another graphical POI geofence report 900, according to another example embodiment. In this example, the graphical POI geofence report 900 depicts multiple sub-areas 902a-902h within the geofence. As described above, these multiple sub-areas 902a-902h may be divided based on demographic information, such as political boundaries.

In another example embodiment, geofence performance may be compared across multiple regions (e.g., cities, states, countries).

It should also be noted that while this document describes geofence analysis based on clicks, the concepts may be extended to consumer actions beyond merely advertising clicks. Ultimately, it may be extended to any type of consumer interaction, such as interactions with offers, payments, and loyalty.

### Example Methods

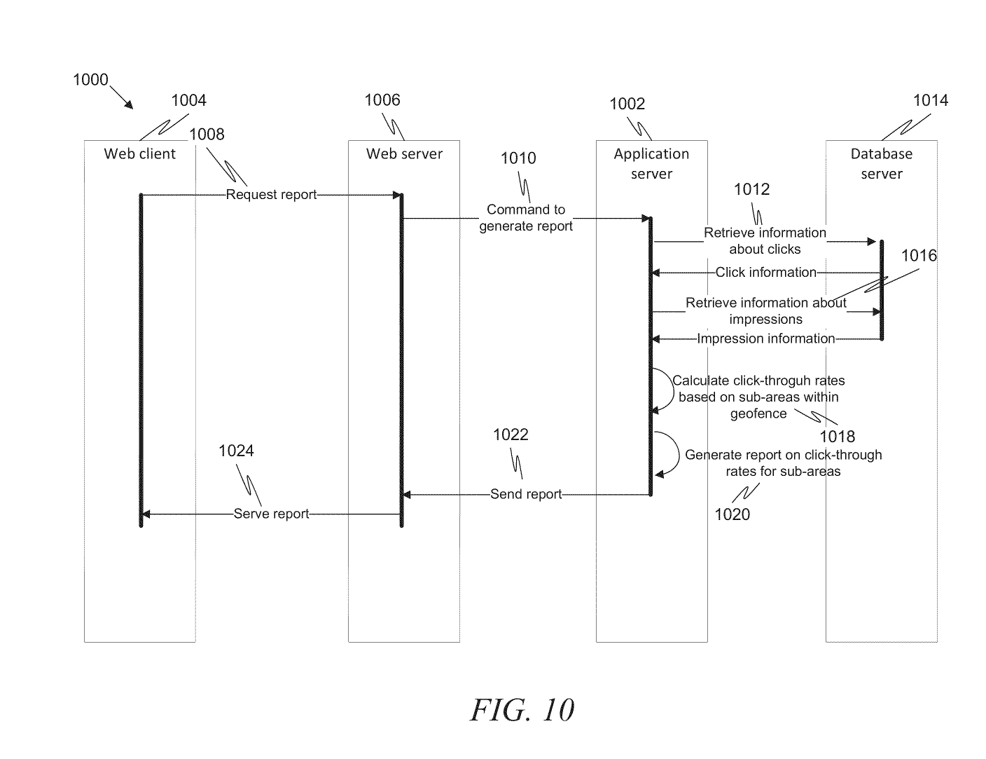

FIG. 10 is an interaction diagram illustrating a method 1000, in accordance with an example embodiment, for tracking an advertising campaign. An application server 1002 interacts with a web client 1004 via a web server 1006. The web client 1004 may issue a request for a geofence report to the web server 1006 at operation 1008. At operation 1010, the web server 1006 issues a command to the application server 1002 to generate the report. At operation 1012, the application server 1002 issues a command to a database server 1014 to retrieve information about clicks made on advertisements distributed to mobile devices in the advertising campaign. This information may include metadata containing identifications of physical locations where corresponding mobile devices were located when corresponding clicks were made. At operation 1016, the application server 1002 issues a command to the database server 1014 to retrieve information about numbers of impressions made on mobile devices in the advertising campaign. At operation 1018, the application server 1002 calculates click-through-rates of impressions within the defined geofence, broken down into click-through-rates in each of a plurality of different sub-areas within the defined geofence based on physical locations identified in the metadata. At operation 1020, the application server 1002 generates a report identifying the click-through-rates for the different sub-areas within the defined geofence. At operation 1022, the application server 1002 returns this report to the web server 1006. At operation 1024, the web server 1006 serves this report to the web client 1004 for display to a user.

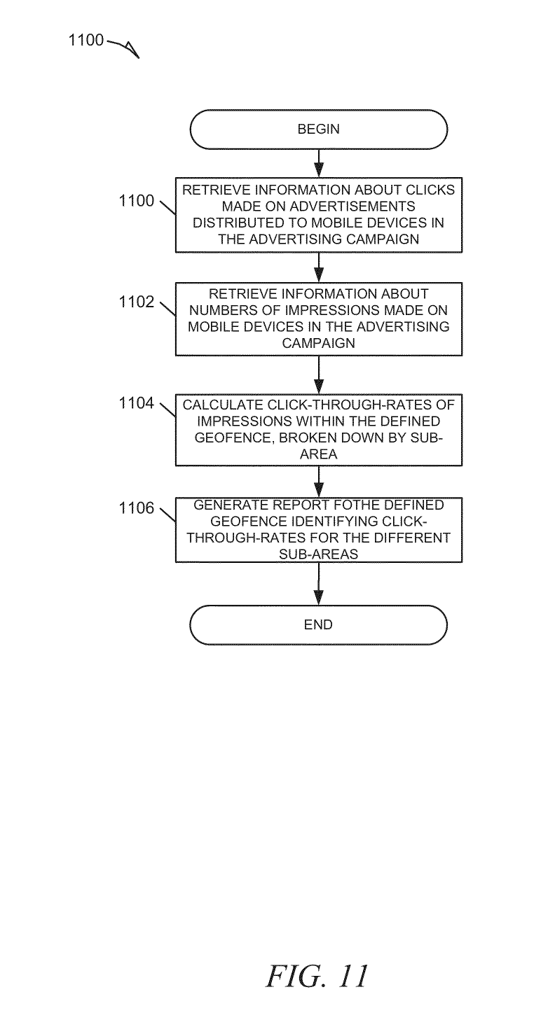

FIG. 11 is a flowchart illustrating a method 1100, in accordance with an example embodiment, for tracking an advertising campaign. At operation 1100, information about clicks made on advertisements distributed to mobile devices in the advertising campaign is retrieved. The information may include metadata containing identifications of physical locations where corresponding mobile devices were located when the corresponding clicks were made. At operation 1102, information about numbers of impressions made on mobile devices in the advertising campaign is retrieved. At operation 1104, click-through-rates of impressions within the defined geofence are calculated and broken down into click-through-rates in each of a plurality of different sub-areas within the defined geofence based on the physical locations identified in the metadata. At operation 1106, a report is generated for the defined geofence identifying the click-through rates for the different sub-areas within the defined geofence.

In another example, mobile retargeting is performed to further improve the analysis of click-through-rates. In mobile retargeting, some of the information regarding clicks is discarded based on knowledge obtained regarding the users of devices on which advertisements were clicked. For example, mobile device location may be tracked to distinguish between users who are residents of the geofence in which an advertisement was served, and users who are from other locations and merely visiting or temporarily within the geofence. This may be highly relevant to advertisers who are local merchants or who represent local merchants, and therefore may be more interested in the effectiveness of an advertising campaign on likely customers (residents) than on random passers-through. In such instances, the information derived from non-residents may be discarded or otherwise ignored during the analysis and presentation portions.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g. as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

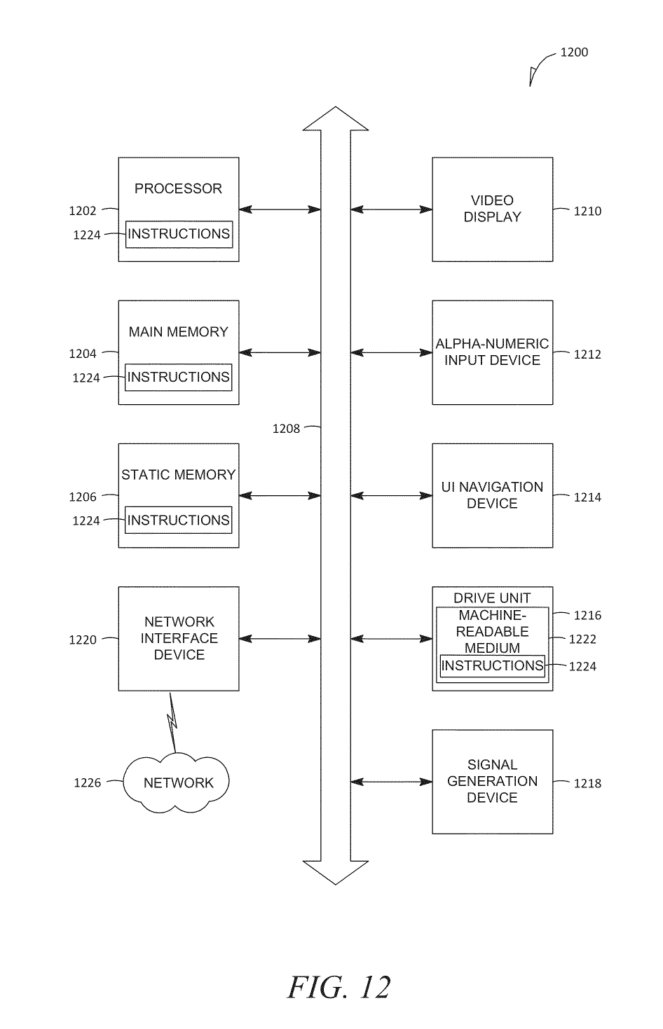

FIG. 12 is a block diagram of machine in the example form of a computer system 1200 within which instructions 1224 for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a PDA, a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU), a graphics processing unit (GPU) or both), a main memory 1204 and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard), a user interface (UI) navigation device 1214 (e.g., a mouse), a disk drive unit 1216, a signal generation device 1218 (e.g., a speaker) and a network interface device 1220.

### Machine-Readable Medium

The disk drive unit 1216 includes a machine-readable medium 1222 on which is stored one or more sets of data structures and instructions 1224 (e.g., software) embodying or used by any one or more of the methodologies or functions described herein. The instructions 1224 may also reside, completely or at least partially, within the main memory 1204, static memory 1206, and/or within the processor 1202 during execution thereof by the computer system 1200, the main memory 1204 and the processor 1202 also constituting machine-readable media.

While the machine-readable medium 1222 is shown in an example embodiment to be a single medium, the term “machine-readable medium” may include a single medium or multiple media (e.g., a centralized or distributed database, and/or associated caches and servers) that store the one or more data structures or instructions 1224. The term “machine-readable medium” shall also be taken to include any tangible medium that is capable of storing, encoding or carrying instructions for execution by the machine and that cause the machine to perform any one or more of the methodologies of the present disclosure, or that is capable of storing, encoding or carrying data structures used by or associated with such instructions. The term “machine-readable medium” shall accordingly be taken to include, but not be limited to, solid-state memories, and optical and magnetic media. Specific examples of machine-readable media include non-volatile memory, including by way of example, semiconductor memory devices (e.g., Erasable Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks.

### Transmission Medium

The instructions 1224 may further be transmitted or received over a communications network 1226 using a transmission medium. The instructions 1224 may be transmitted using the network interface device 1220 and any one of a number of well-known transfer protocols (e.g., HTTP). Examples of communication networks include a LAN, a WAN, the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although the present inventive subject matter has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense.

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” and “third,” and so forth are used merely as labels, and are not intended to impose numerical requirements on their objects.

1. A method of tracking an advertising campaign, the method comprising:
retrieving information about clicks made on advertisements distributed to mobile devices in the advertising campaign, wherein the information about clicks includes metadata containing identifications of physical locations where corresponding mobile devices were located when corresponding clicks were made;
retrieving information about numbers of impressions made on the mobile devices in the advertising campaign, the advertising campaign distributing impressions in a defined geofence;
calculating click-through-rates of impressions within the defined geofence, broken down into click-through-rates in each of a plurality of different sub-areas within the defined geofence based on the physical locations identified in the metadata; and
generating a report for the defined geofence identifying the click-through-rates for the different sub-areas within the defined geofence.

2. The method of claim 1, wherein the plurality of different sub-areas within the defined geofence include a plurality of concentric circles radiating away from a center point of the defined geofence.

3. The method of claim 1, wherein the plurality of different sub-areas within the defined geofence includes a plurality of points of interest within the defined geofence.

4. The method of claim 1, wherein the plurality of different sub-areas within the defined geofence includes a plurality of areas broken down based on demographic information regarding residents within the plurality of areas.

5. The method of claim 1, further comprising performing mobile retargeting and ignoring clicks from certain users based on the mobile retargeting, prior to the generating of the report.

6. The method of claim 1, wherein the method is performed repeatedly without user intervention to provide a dynamically updated report.

7. The method of claim 2, wherein the concentric circles comprise a first set of concentric circles of a first size and a second set of concentric circles of a second size.

8. The method of claim 2, wherein the report comprises a graph showing click-through-rates on one axis and a sub-area of the geofence on another axis.

9. The method of claim 1, wherein the identifications of physical locations include global positioning system (GPS) coordinates.

10. A system comprising:
a database server coupled to a database;
a web server; and
an application server containing a geofence reporting module, wherein the geofence reporting module is configured to:
retrieve information about clicks made on advertisements distributed to mobile devices in an advertising campaign from the database server, wherein the information about clicks includes metadata containing identifications of physical locations where corresponding mobile devices were located when corresponding clicks were made;
retrieving information about numbers of impressions made on the mobile devices in the advertising campaign from the database server, the advertising campaign distributing impressions in a defined geofence;
calculating click-through-rates of impressions within the defined geofence, broken down into click-through-rates in each of a plurality of different sub-areas within the defined geofence based on the physical locations identified in the metadata;
generating a report for the defined geofence identifying the click-through-rates for the different sub-areas within the defined geofence; and
transmitting the report to a web client via the web server.

11. The system of claim 10, further comprising:
an Application Programming Interface (API) server.

12. A non-transitory computer-readable storage medium comprising instructions that, when executed by at least one processor of a machine, cause the machine to perform operations of tracking an advertising campaign, the method comprising:
retrieving information about clicks made on advertisements distributed to mobile devices in the advertising campaign, wherein the information about clicks includes metadata containing identifications of physical locations where corresponding mobile devices were located when corresponding clicks were made;
retrieving information about numbers of impressions made on the mobile devices in the advertising campaign, the advertising campaign distributing impressions in a defined geofence;
calculating click-through-rates of impressions within the defined geofence, broken down into click-through-rates in each of a plurality of different sub-areas within the defined geofence based on the physical locations identified in the metadata; and
generating a report for the defined geofence identifying the click-through-rates for the different sub-areas within the defined geofence.

13. The non-transitory computer-readable storage medium of claim 12, wherein the plurality of different sub-areas within the defined geofence includes a plurality of concentric circles radiating away from a center point of the defined geofence.

14. The non-transitory computer-readable storage medium of claim 12, wherein the plurality of different sub-areas within the defined geofence includes a plurality of points of interest within the defined geofence.

15. The non-transitory computer-readable storage medium of claim 12, wherein the plurality of different sub-areas within the defined geofence includes a plurality of areas broken down based on demographic information regarding residents within the plurality of areas.

16. The non-transitory computer-readable storage medium of claim 12, further comprising performing mobile retargeting and ignoring clicks from certain users based on the mobile retargeting, prior to the generating of the report.

17. The non-transitory computer-readable storage medium of claim 12, wherein the method is performed repeatedly without user intervention to provide a dynamically updated report.

18. The non-transitory computer-readable storage medium of claim 13, wherein the concentric circles comprise a first set of concentric circles of a first size and a second set of concentric circles of a second size.

19. The non-transitory computer-readable storage medium of claim 13, wherein the report comprises a graph showing click-through-rates on one axis and a sub-area of the geofence on another axis.

20. The non-transitory computer-readable storage medium of claim 12, wherein the identifications of physical locations include global positioning system (GPS) coordinates.
